(19) United States
(12) Patent Application Publication
(10) Pub. No.: US 2005/0129215 A1
(43) Pub. Date: Jun. 16, 2005

(54) Payroll based on communication switch statistics

(75) Inventor: Jane Smith Parker, Douglasville, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(73) Assignee: Jane Smith Parker

(21) Appl. No.: 10/735,405

(22) Filed: Dec. 12, 2003

(51) Int. Cl. H04M 5/00; H04M 3/00; H04M 3/22; H04M 3/08; H04M 1/24; G06F 17/60

(52) U.S. Cl. 379/265.06; 379/32.01; 705/14; 705/32

(57) ABSTRACT

Systems and methods for a payroll system, which in one embodiment among many, can be broadly summarized by a representative method of obtaining a set of switching statistics from a communication switch and integrating this set of switching statistics with a set of work statistics of an operator to, for example, determine a bonus payment to the operator if the operator exceeds an expected efficiency. In one embodiment, a payroll system has logic configured to obtain a set of switching statistics from a communication switch and integrate this set of switching statistics with a set of work statistics of an operator to calculate a bonus payment to the operator if the operator exceeds an expected efficiency.

### TECHNICAL FIELD

The present disclosure is generally related to payroll systems and, more particularly, is related to operator payroll systems.

### BACKGROUND

An employee payroll calculation is typically carried out using employee attendance data and an appropriate pay scale. The employee attendance data may be obtained over a weekly, bi-weekly, or monthly period depending on the frequency of salary payments; while the pay scale for the particular employee is typically determined on an annual basis. Attendance data may be collected via manual and/or automated means such as punch cards, log books, entry badges, time sheets, and roll calls. Presumably, this attendance data reflects, with varying degrees of accuracy, the actual amount of time that was spent by the employee in performing his or her job functions. The degree of accuracy is dependent on a number of parameters such as employee diligence, employee honesty, and the work environment. It is also dependent on automated and/or manual monitoring mechanisms that are employed to record, report, and evaluate the actual amount of time spent by an individual employee carrying out his or her job functions. Monitoring mechanisms include project timesheets, video surveillance systems, and audio recording systems.

The degree of accuracy in assessing the actual amount of time spent on carrying out a job is further dependent upon the nature of the job itself. For example, while it may be difficult to accurately assess the amount of time spent by a mathematician in formulating an equation, it is relatively easier in a manufacturing job to count the number of finished goods and estimate the amount of time spent by an employee in producing these goods. Overall, in many cases, a calculation of the actual amount of time spent on a job, turns out to be an inexact process subject to approximation and guesswork.

While existing schemes for estimating an employee's actual working hours suffer from various shortcomings and inaccuracies, an evaluation of an employee's quality of work also turns out, in many cases, to be an imprecise process, thereby handicapping existing methods of providing a bonus payment to an employee based on a combination of the amount as well as the quality of the employee's work.

In terms of quality of work, employee performance reviews are typically carried out on an annual or a semi-annual basis, where the performance of an employee over a twelve month or six month period is evaluated and a pay raise or a bonus is suitably awarded. In many instances, the employer and the employee do not see eye to eye on the evaluation results because a number of parameters that are used to assess the employee are often subjective, and dependent on the employer's personal perceptions of the employee as well as an unreliable memory of the employee's past performance. Often, during such reviews, the attendance information is coupled to the employee's performance data in a peripheral manner, with the attendance information being used merely as a tool to deny an employee a salary raise or a bonus.

Inaccurate and subjective assessments of job performance are minimized to some degree, in certain types of jobs that are somewhat repetitive in nature. For example, it is relatively straightforward to maintain a daily attendance log of a switchboard operator, and periodically/randomly monitor telephone conversations to evaluate the quality of the operator's performance. However, even under these conditions the attendance information is not very well integrated into the work quality of the operator when the annual performance review is conducted.

In a call center environment, telephone operators are employed to provide a variety of customer services. Managers of call centers routinely monitor these telephone operators, by carrying out what are known in the industry, as “observations.” These observations are typically carried out a certain number of times every month upon each operator of the call center, to evaluate individual operator performance. While some aspects of these observations, such as for example, evaluating the contents of the phone conversations, are again subjective in nature, other evaluation parameters such as the length of time that the operator is physically seated at his or her position and the number of calls that are dropped by the operator, can be measured with a higher degree of objectivity and accuracy.

Typically, even in such an environment, several disparate pieces of data are processed by several different individuals to obtain an assessment of an operator's work performance and to calculate an appropriate pay raise or bonus payment. Specifically, the quality and quantity parameters of an operator's job are often measured by two different individuals and the two pieces of information are integrated most often by a third individual, such as a payroll employee, in one example, in a manual fashion that leaves much to be desired.

Such a payroll system where several individuals such as managers and supervisors collect employee attendance and performance data, followed by payroll staff using this data to produce paychecks and bonuses, is vulnerable to various errors and shortcomings.

It is therefore desirable to implement a payroll system that provides a good degree of objectivity while saving time and money.

### SUMMARY OF THE DISCLOSURE

One embodiment among others, of the present disclosure includes operating a payroll system by obtaining a set of switching statistics from a communication switch and integrating this set of switching statistics with a set of work statistics of an operator to, for example, determine a bonus payment to the operator if the operator exceeds an expected efficiency.

Other systems, methods, and/or computer program products according to embodiments will be or become apparent to one skilled in the art upon review of the following drawings and detailed description. It is intended that all such additional systems, methods, and/or computer program products be included within this description, and be within the scope of the present disclosure.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in drawings, like reference numerals designate corresponding parts throughout the several views.

FIG. 1 is a block diagram of a workforce management system communicatively coupled to a communications switch that provides switching services to one or more workforce centers.

FIG. 2 is a block diagram of a workforce management system comprising a network of computing elements, the management system being communicatively coupled to a communication switch that is a part of the POTS network and/or the Internet.

FIG. 3 is a block diagram illustrating various functional blocks of one embodiment of a payroll system incorporated inside the workforce management system of FIG. 1.

FIG. 4 is a block diagram illustrating various functional blocks of one embodiment of a communication switch processing unit that is located inside the communications switch of FIG. 1, the communication switch processing unit being communicatively coupled to the workforce management system of FIG. 3.

FIG. 5 is a flowchart describing an embodiment of a method for implementing the payroll system of FIG. 3.

FIG. 6 illustrates a few method steps of the flowchart of FIG. 5.

### DETAILED DESCRIPTION

While the description below refers to certain exemplary embodiments, it is to be understood that the disclosure is not limited to these particular embodiments. On the contrary, the intent is to cover all alternatives, modifications and equivalents included within the spirit and scope of the disclosure. Also, the terminology used herein is for the purpose of description and not of limitation.

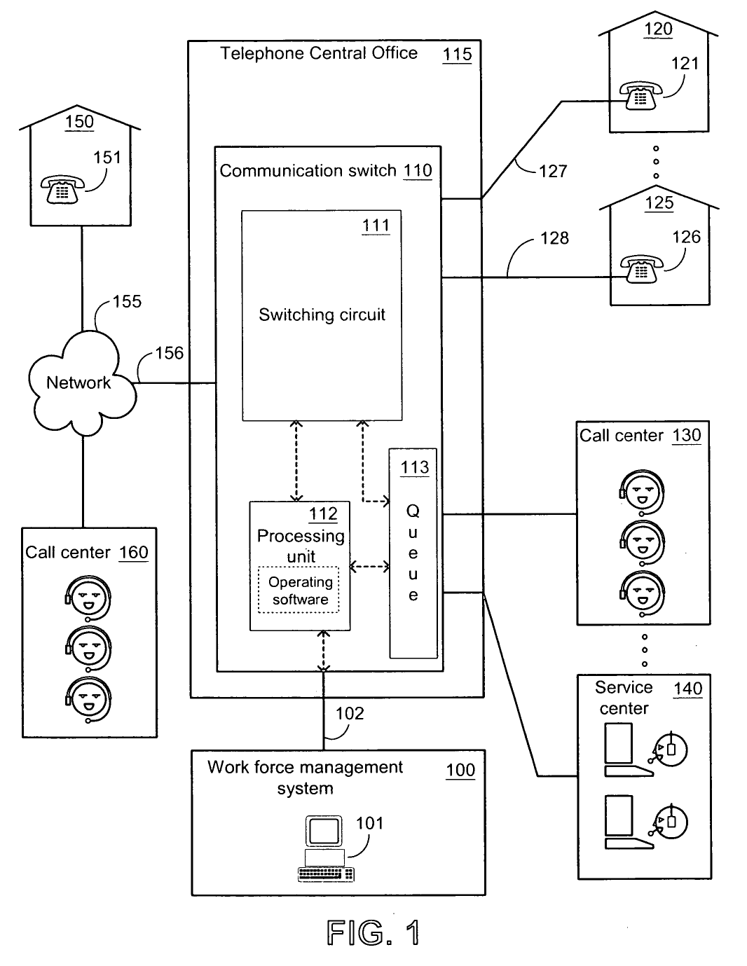

FIG. 1 is a block diagram of a workforce management system 100 communicatively coupled to a communications switch 110, which in a first exemplary embodiment, is a plain old telephone service (POTS) switch located in a telephone central office (CO) 115. The POTS switch is connected on its trunk side via link 156 to a network 155, which in this first embodiment, is the public switched telephone network (PSTN). The POTS switch of this embodiment, provides telephone service to many customers, such as residential customers located in residences 120 and 125 that are connected to the line side of the POTS switch via links 127 and 128 that constitute the telephone local loop. These residences contain telephones 121 and 126 as shown, but may additionally accommodate communication devices such as PCs used by the residential customers for Internet access.

The POTS switch of this embodiment, is further configured to provide telephone services via the PSTN of this embodiment, to an additional residential customer located in residence 150. The residential customer in residence 150 communicates with a customer in residence 120 by obtaining a connection through the PSTN and through the POTS switch This type of customer who is located outside a local access transport area (LATA) served by the switch, is classified as a long-distance customer, and is sometimes referred to as an inter-LATA customer.

Communication switch 110 is further configured to provide telecommunication services such as routing telephone calls from telephone customers in residences 120, 125, and 150 to telephone operators located in a call center 130. The telephone operators in call center 130 provide a number of customer services such as directory assistance and operator-assisted call connections.

In a second exemplary embodiment, communication switch 110 comprises a digital subscriber line access multiplexer (DSLAM) to provide Internet access and various data services to residences 120, 125, and 150, and also to business customers located in businesses (not shown) that are connected to the DSLAM either via the local loop or via network 155. The DSLAM of this second exemplary embodiment, is typically configured to route data traffic to a server that is located in an Internet service provider (ISP) location. Routing of data traffic is carried out over network 155 that in this exemplary second embodiment, comprises the Internet.

In a third exemplary embodiment, communication switch 110 comprises a device that is referred to in the industry as a softswitch, or alternatively comprises a device that is referred to in the industry as a gateway. The softswitch/gateway of this third exemplary embodiment, switches data packets while providing data services to residences 120, 125, and 150, and also to business customers located in businesses (not shown) that are connected to the device either via the local loop or via network 155. Network 155 will comprise the Internet in this third exemplary embodiment.

The softswitch/gateway of this exemplary embodiment is not necessarily confined to providing data services, but can also be further configured to provide voice services over a packet network such as the Internet. One example of such a voice service uses voice-over-Internet protocol (VoIP) to carries voice data as IP packets over the network. With reference to this example, residence 150 or a business (not shown) that is connected to the Internet (network 155) is, in various embodiments, an international customer located in a country outside the country in which the communication switch 110 is located. Similarly, a call center 160 that is shown connected into network 155 is, in various embodiments, a call center located in a foreign country. Call center 160 and other service centers that are connected to network 155 at an international location, is, in various embodiments, used to provide services to customers such as the ones in residences 120, 125, and 150.

Drawing further attention to FIG. 1, service center 140 is shown connected to communications switch 110 and facilitates service center operators in providing various services to residential and/or business customers. Such services include functions that are similar to that provided by the call center operators, but also comprise many other types of services that include voice as well as data operations.

As a first example among many, such services include manually responding to e-mails when such responses do not require telephone conversations. A second example involves responding via telephone and/or e-mail to customer queries related to product support. A third example involves handling of a business transaction such as an automated credit card payment through a business website.

It will be understood that such transactions encompass a wide variety of voice transactions carried out over the PSTN, as well as data transactions carried out over a private and/or a public data network including the PSTN and the Internet. It further includes voice transactions that are carried over data networks, for example, as a Voice-over-IP call.

For purposes of explanation, hereon, it will be understood that the use of the term “call center” will generally apply to both call centers as well as service centers, unless specifically stated otherwise. It will also apply not merely to centers that cater to telephone services and data services, but also to a variety of domestic as well as international services, business or otherwise, that are served via a communication switch.

Work force management system (WFMS) 100 that is shown communicatively coupled to switch 110, includes a workforce computer system 101 that in various embodiments, comprises one machine or several machines. In various embodiments, these machines are PCs, workstations, or other computing platforms, that are used in an individual configuration, or comprise a network of several units. WFMS 100 is typically located either inside CO 115 or in an outside office. Typically, WFMS 100 is located in an outside office that is, in certain instances, a geographically remote office located in a city other than the city in which the CO 115 is located.

WFMS 100 is configured to manage certain operations of centers such as call center 130 and service center 140. Such operations include call-volume analysis, call-volume prediction, and producing work schedules for the call center operators based on the predicted call-volume. Call-volume analysis is carried out by obtaining from the communication switch 110, call-statistics such as total number of calls routed to one or more centers, and types of such calls routed; and also by obtaining from one or more call centers, call-handling-statistics such as calls answered, calls abandoned, and average wait times. Call-statistics are typically obtained via digital data that is transported on link 102 from switch 110 to WFMS 100. In various embodiments, link 102 uses various types of hardware and software. In one example among many, link 102 is a circuit-switched link such as a T1 line carrying TDM data. In a second example, link 102 is a packet-switched link carrying data packets using a TCP/IP format.

Once WFMS 100 receives the call-statistics, a call-load history is generated from which future call-loads are predicted. Based on these predictions, the work force in one or more call centers are scheduled in a process that is known in the industry as “tours.” Tours are used to adjust the number of call operators at various instances of time depending upon expected call volume. Furthermore, switching processes in switch 110 that are related to routing of calls to the call centers, as well as providing call-weighting (e.g., by adding wait times) to such calls, can be modified at switch 110 upon request from WFMS 100. Such a request is often carried out via telephone calls between the staff of WFMS 100 and those of CO 115.

WFMS 100 is also configured to handle certain other functions related to call center operators. Some of these functions include payroll, attendance, record keeping, and personnel management tasks such as hiring and firing.

Drawing attention to communication switch 110 of FIG. 1, a few operational blocks that are associated with call center operations are shown inside switch 110. Switching circuit 111 carries out the switching function to switch calls originated by customers such as a residential customer from residence 120. Such a call may relate to directory assistance where the customer is seeking directory information that requires manual servicing by an operator in call center 130. Switching circuit 111 provides the necessary connections to direct this call, in digital data form, to a queue 113. Queue 113 is typically, a first-in-first-out (FIFO) buffer system that regulates the transfer of this call together with any others that may be occurring during this time, to call center 130 or service center 140. The queueing process also typically incorporates a weighting scheme to decide the order in which these calls are placed into, and consequently routed out of, the queue 113. One example among many, of a weighting scheme uses a “wait time” factor that determines how quickly an individual call is processed and transported out of the switch. The call is routed from queue 113 to a call center operator in call center 130 for example. Processing unit 112 is typically, a central processing unit (CPU) comprising hardware and software that is a part of communication switch 110. The software inside processing unit 112 includes operating software that controls switching circuit 111, queue 113 and other circuits inside communication switch 110. Processing unit 112 further includes software for interfacing switch 110 to WFMS 100 via link 102.

It will be understood that similar mechanisms for switching and queuing can be employed to interface switch 110 to call center 160 to provide customer service for customers in residences 120, 125, and 150. It will also be understood that WFMS 100 can be communicatively coupled to communication switch 110 through network 155, thereby allowing WFMS 100 to be remotely located.

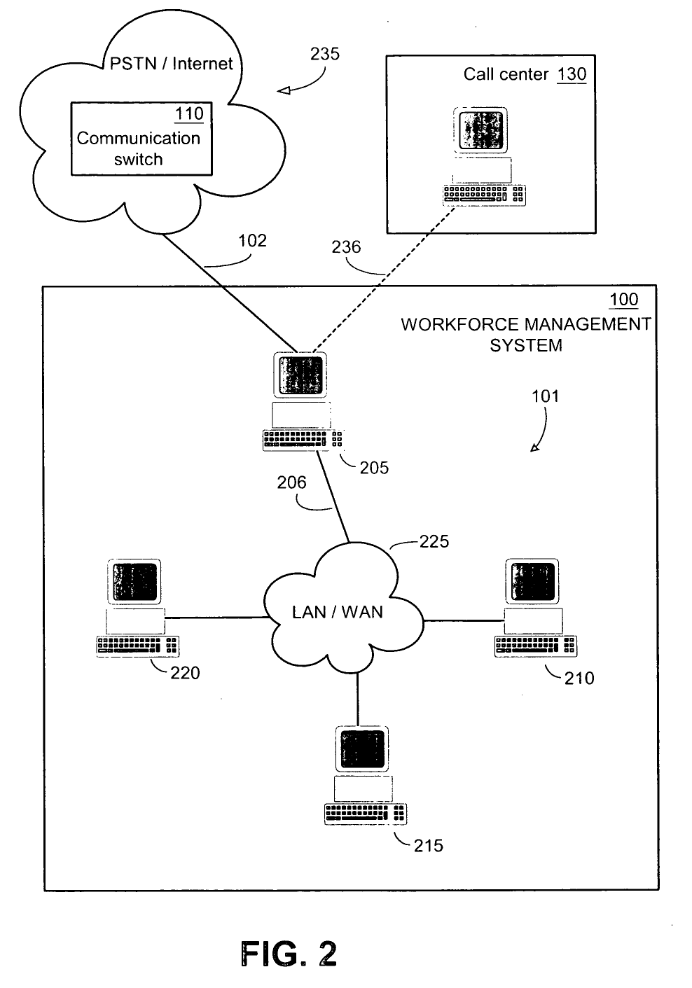

FIG. 2 illustrates one exemplary embodiment among several such embodiments, wherein WFMS 100 comprises workforce computer system 101 configured as a network of computing elements. Computing elements 205, 210, 215, and 220 are four example elements that comprise four PCs, four workstations, four processing platforms, and combinations thereof. Element 205 operates in this example as a server/gateway device. While four such elements are shown in FIG. 2 it will be understood that the number of elements in such a network configuration can be any number greater than two. The four elements of FIG. 2 are interconnected to each other by a network 225 that is a local area network (LAN) and/or a wide area network (WAN) comprising a variety of hardware and software elements that incorporate various standards and formats. One example among many, of such a network is an Ethernet LAN transporting data packets using an Ethernet protocol. A second example is a WAN transporting data cells in an ATM format. The four elements shown in this example, are located inside a single building or alternatively, be housed in several buildings that include one or more call centers. They can also be interconnected to each other, to other communication devices, and to communication links in several other appropriate configurations.

In a first exemplary configuration, element 205 operates in a client-server configuration where communication switch 110 that is shown as a part of network 235, operates as a server and element 205 operates as its client. In the context of such a configuration, link 102 is a communication link that transports data packets and network 235 is a packet network such as the Internet.

In a second exemplary configuration, element 205 operates in a master-slave configuration where communication switch 110 that is shown as a part of network 235, operates as a master device and element 205 is its slave. In the context of this second exemplary configuration, link 102 is a communication link that transports circuit-switched data and network 235 is a circuit-switched network such as the PSTN.

In some embodiments, element 205 is communicatively coupled to one or more computers that are located in one or more call centers, either through communication switch 110 or directly through other communication links as indicated by the dashed line of link 236. FIG. 2 shows one example where a computer in call center 130 is coupled to element 205 through link 236. Link 236 operates in a manner similar to that described for link 102 above. Among other data, administrative information, such as employee work statistics, can be electronically communicated by the computer in call center 130 to the computing element 205.

Generally, element 205 provides a number of software application modules that are used locally by the computing elements interconnected via network 225, and/or remotely by the computer in call center 130 as well as computers elsewhere that are communicatively coupled to element 205. While it is not necessary that all these software modules be solely resident in computing element 205, it is generally understood that it is configured in this manner in many system applications.

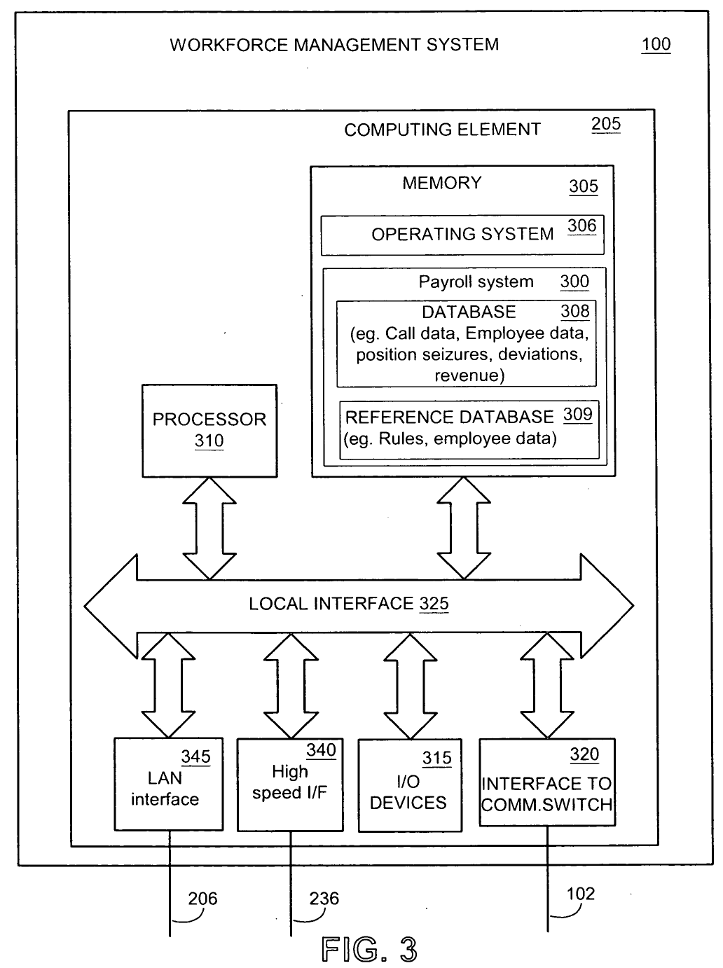

FIG. 3 is a block diagram illustrating various functional blocks incorporated inside element 205 of WFMS 100. Generally, in terms of hardware architecture, as shown in FIG. 3, computing element 205 includes several elements that are communicatively coupled to one another via a local interface 325. Some example elements include, a processor 310, memory 305, a communication switch interface 320, a LAN interface 345, a high-speed interface 340, and one or more input/output (I/O) devices 315 (or peripherals).

The local interface 325 can be, for example but not limited to, one or more buses or other wired or wireless connections, as is known in the art. The local interface 325 can have additional elements, which are omitted for simplicity, such as controllers, buffers (caches), drivers, repeaters, and receivers, to enable communications. Further, the local interface can include address, control, and/or data connections to enable appropriate communications among the aforementioned components.

The processor 310 is a hardware device for executing software, particularly that stored in memory 305. The processor 310 can be any custom made or commercially available processor, a central processing unit (CPU), an auxiliary processor among several processors associated with the computing element 205, a semiconductor based microprocessor (in the form of a microchip or chip set), a macroprocessor, or generally any device for executing software instructions.

The memory 305 includes any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 305 can incorporate electronic, magnetic, optical, and/or other types of storage media. Note that the memory 305 can have a distributed architecture, where various components are situated remote from one another, but can be accessed by the processor 310.

The software in memory 305 includes one or more separate programs, each of which comprises an ordered listing of executable instructions for implementing logical functions. In the example of FIG. 3, the software in the memory 305 includes a payroll system 300 that is one among several embodiments of the present disclosure, and a suitable operating system (O/S) 306. A nonexhaustive list of examples of suitable commercially available operating systems 306 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; or (f) an appliance-based operating system, such as that implemented in handheld computers or personal data assistants (PDAs) (e.g., PalmOS available from Palm Computing, Inc., and Windows CE available from Microsoft Corporation). The operating system 306 essentially controls the execution of other computer programs, such as the payroll system 300, and provides scheduling, input-output control, file and data management, memory management, and communication control and related services.

In some embodiments, the payroll system 300 is implemented using logic incorporated in programs such as a source program, executable program (object code), script, or any other entity comprising a set of instructions to be performed. When a source program, then the program needs to be translated via a compiler, assembler, interpreter, or the like, which may or may not be included within the memory 305, so as to operate properly in connection with the O/S 306. Furthermore, the payroll system 300 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 315 include input devices, for example but not limited to, a keyboard, mouse, scanner, microphone, etc. Furthermore, the I/O devices 315 also include output devices, for example but not limited to, a printer, display, etc. Finally, the I/O devices 315 further include devices that communicate both inputs and outputs, for instance but not limited to, a modulator/demodulator (modem; for accessing another device, system, or network), a radio frequency (RF) or other transceiver, a telephonic interface, a bridge, a router, etc.

Also shown in computing element 205 is a communication switch interface 320 that provides a digital communication link 102 between computing element 205 and a communication switch such as communication switch 110 of FIGS. 1 and 2.

If the computing element 205 is a PC, workstation, or the like, the software in the memory 305 further includes a basic input output system (BIOS) (omitted for simplicity). The BIOS is a set of essential software routines that initialize and test hardware at startup, start the O/S 306, and support the transfer of data among the hardware devices. The BIOS is stored in ROM so that the BIOS can be executed when the computing element 205 is activated.

When the computing element 205 is in operation, the processor 310 is configured to execute software stored within the memory 305, to communicate data to and from the memory 305, and to generally control operations of the computing element 205 pursuant to the software. The payroll system 300 and the O/S 306, in whole or in part, but typically the latter, are read by the processor 310, perhaps buffered within the processor 310, and then executed.

When the payroll system 300 is implemented in software, as is shown in FIG. 3 hereafter, it should be noted that the payroll system 300 can be stored on any computer readable medium for use by or in connection with any computer related system or method. For example, the payroll system 300 can be detailed in a computer program or script that runs on a stand-alone server, a network server, or on one or more computers that are part of a network.

In the context of this document, a computer readable medium is an electronic, magnetic, optical, or other physical device or means that can contain or store a computer program for use by or in connection with a computer related system or method. The payroll system 300 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the payroll system 300 is implemented using hardware logic, the payroll system 300 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. The hardware can be housed in a stand-alone computer or in one or more computers of a network.

Drawing attention to payroll system 300 of FIG. 3, two functional blocks among many are shown as a database 308 and a reference database 309. While database 308 and reference database 309 are shown in FIG. 3 as two separate blocks, this illustration has been done merely for the sake of convenience in describing their operations. Both databases can be integrated into a single database, and the data contained in these databases can be stored as well as shared between the two blocks shown. Other functional blocks that operate to implement payroll system 300 have not been shown, and will be understood in the context of implementations as described in the following pages.

Database 308 comprises, in one exemplary embodiment, data that is formatted for processing by a Structured Query Language (SQL) program. In alternative embodiments, other programs such as, but not limited to, Microsoft Excel™, Microsoft Access™, and Oracle are used. Also, in other embodiments, unformatted data is stored in database 308.

In one of several embodiments, database 308 comprises call-related statistics that have been provided by a communication switch, such as communication switch 110 of FIGS. 1 and 2, through communication switch interface 320. In this context, communication switch interface 320 comprises a digital interface device that performs an electronic handshake with processing unit 112 located inside the communication switch 110, and downloads pertinent data via link 102. Alternatively, other methods are employed to configure database 308. One such method includes a manual entry by an operator through I/O devices 315 that in one example, is a keyboard or a mouse. Manual entry includes entering data values into a spreadsheet for example, the spreadsheet being stored in database 308. The operator can obtain outputs such as printouts and on-screen displays of the spreadsheet, as well as other information pertinent to computing element 205 via suitable devices such as printers and displays of I/O devices 315.

In one or more embodiments, call-related statistics include, but are not limited to the number of calls forwarded from communication switch 110 to one or more call centers, types of calls (e.g. directory assistance, toll, and toll-free), telephone numbers, call duration, originating source (e.g. phone number of calling party), call center identification, and call center related data as well. Call center related data includes operator performance measurements using industry-wide practices, such as, but not limited to, position seizures, revenue and deviations. Such operator performance measurements indicate the efficiency in call handling—how many calls were received, how long was the average wait time, how many calls were unanswered, how many calls were dropped etc.

Other elements of data/information that are stored in database 308 or in database 309 will be identified or made obvious by further explanations that are done below with reference to other figures.

Computing element 205 also communicates with various devices, such as personal computers, that are located in one or more call centers, to obtain data that is then stored in database 308. The communication between computing element 205 and the call centers takes place through communication switch 110, or through alternative means that do not involve communication switch 110. Such alternative means include wireline/wireless communication devices such as microwave links, cell phones, and fiberoptic transceivers. Also included is written material, for example, documentation that is exchanged by regular mail between operators of the call centers and those of WFMS 100.

Reference database 309 contains additional data that is relevant to payroll system 300, for example, but not limited to, employee data related to the various operators employed in the call centers. This data includes employment history information such as seniority and pay scale. It also includes employee history data that incorporates attendance and absence information. Some examples of information contained in the employment history information of each employee, include, but is not limited to, office name of call center, employee number, employee name, social security number, paid hours, worked time, benefit hours, illness hours, and exempt hours.

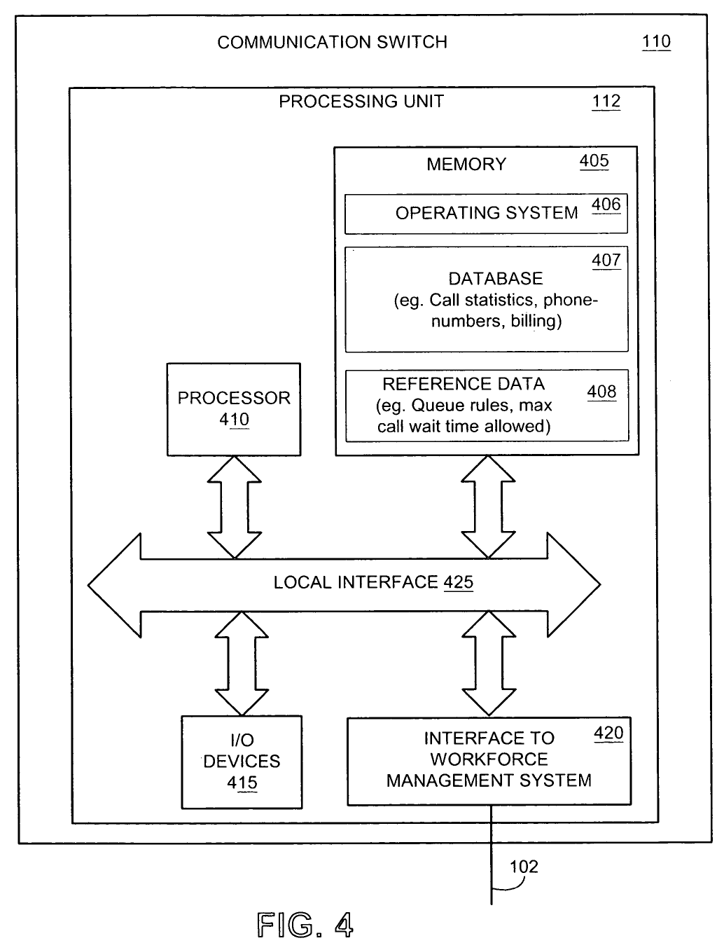

FIG. 4 is a block diagram illustrating various functional blocks incorporated inside processing unit 112 of communication switch 110. Generally, in terms of hardware architecture, as shown in FIG. 4, processing unit 112 includes a processor 410, memory 405, a WFMS interface 420, and one or more input and/or output (I/O) devices 415 (or peripherals) that are communicatively coupled via a local interface 425. It will be understood by persons of ordinary skill in the art, that the description of the hardware in FIG. 4 can be generally understood from the description provided for the equivalent hardware blocks shown in FIG. 3.

Processing unit 112 is generally configured to perform functions that are typically carried out by a controller circuit of a communication switch such as communication switch 110. Such functions typically encompass operations, administration, maintenance, and provisioning (OAMP) functions that are associated with switch 110. Additionally, processing unit 112 is configured to interface with WFMS 100 and to provide switching statistics to WFMS 100. This is carried out via WFMS interface 420 that transmits digital data to WFMS 100 through link 102.

Memory 405 includes database 407 and reference database 408. While shown as two distinct database located inside processing unit 112, it will be understood that this has been done merely for purposes of explanation, and several other database configurations can be used alternatively. These configurations include the use of databases located inside elements other than processing unit 112. Database 407 contains data is used by communication switch 110 and/or the payroll system 300 (FIG. 3). Such data relates to the switching functions carried out by communication switch 110, and also for implementing the payroll system 300. Alternatively, it is solely dedicated to providing the data pertinent to, and requested by, payroll system 300.

In the example where communication switch 110 is a POTS switch, this data comprises call-related data, such as, but not limited to, call routing software, billing information, call-completed data such as call origination details, length of call, destination details, time data etc., call set-up data such as programmed wait times, call density, average wait time, and other such data.

Reference database 408 typically holds data that is specifically relevant to payroll system 300. Such data includes, but is not limited to, call center information, queuing rules for routing calls to the call/service centers, and wait time information for programming upon calls originating from specific geographical locations served by the switch.

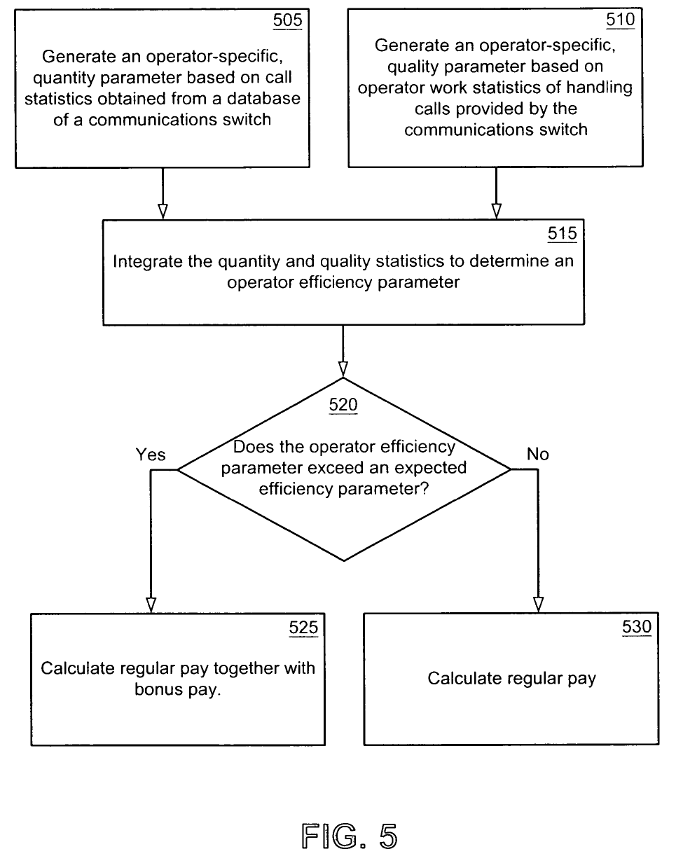

FIG. 5 is a flowchart to describe one embodiment, among several embodiments, for implementing the payroll system 300 shown in FIG. 3. It is to be understood that any process steps or blocks shown in FIG. 5 represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved. Code may also be contained in several devices of the disclosure, and may not be necessarily confined to any particular device. The explanation below, while possibly implying code residency and functionality in certain devices, does so solely for the purposes of explaining the concept behind the disclosure, and the description should not be construed as a limiting parameter for the disclosure's various implementations in other applications.

Drawing attention to FIG. 5, in block 505, an operator-specific, quantity parameter is generated based on call statistics obtained from a communications switch. The quantity parameter comprises cumulative call routing statistics that relate to one or more call/service center. In connection with such statistics, two terms, among many that are typically used in the industry, are “number of calls offered” (NCO) and “number of calls handled” (NCH). NCO is a count of calls that come into an inbound call center, including calls that are abandoned because they are not answered in time. NCH, which is also sometimes referred to as “contacts,” is a count of calls that are actually handled by an operator. NCH is arrived at by subtracting a “number of calls abandoned” (NCA) from NCO.

In block 510, an operator-specific quality parameter is generated based on operator work statistics, such as, but not limited to, call-handling statistics. The quality parameter incorporates information that is specific to an operator whose quantity parameters have been obtained in block 505. The parameter generally defines the response characteristics of the operator in handling calls that were routed to the operator, and is a measure of the operational efficiency of a particular operator. One example, among many, of call-handling statistics, is typically referred to in the industry, as “total work time” (TWT). TWT, which is sometimes referred to as “post call processing” (PCP) or “wraptime,” refers to the total amount of time an operator is unavailable for new calls as he/she is working on issues related to past calls.

In block 515, the quantity parameter of block 505 is integrated with the quality parameter of block 510 to determine an operator efficiency parameter. The term “integrated” as used in block 515, comprises one or more mathematical operations, such as, but not limited to, addition, subtraction, multiplication, integration, differentiation, mean, median, average, and other such statistical calculations. The term “integrated” as used in block 515, further comprises one or more operations mathematical and otherwise, that are performed to “combine” one or more parameters —numeric, alpha-numeric, and non-numeric. In one example among many, of such a combining operation, where a first department labels overtime as “OT” and a second department labels it “OH,” the two are “combined” to form a common term—“cost overhead.”

To further illustrate the term “integration” of block 515, in one embodiment, among many, where the operator efficiency parameter is an “average work time” (AWT), the AWT is obtained by “integrating” TWT with NCH. In this embodiment, integrating the two terms comprises dividing quality parameter TWT by the quantity parameter NCH. In a second embodiment, where the operator efficiency parameter is an “annual AWT” that is used to calculate an annual bonus payment, a set of monthly TWT parameters is mathematically integrated to obtain an “annual TWT” parameter. A set of monthly NCH values is also mathematically integrated to obtain an “annual NCH” parameter. The annual AWT parameter (the operator efficiency parameter) is then obtained by dividing the annual TWT parameter by the annual NCH parameter.

While a few examples have been outlined in this disclosure, it will be understood that these are merely exemplary in nature, and in alternative embodiments alternative processes of manipulating the quality and quantity parameters, separately or combined, will be used to obtain an operator efficiency parameter.

Such an efficiency parameter is used as a relative measure of an operator's efficiency in comparison to other operators in one or more call centers. Alternatively, as shown in block 520, these efficiency parameters are used to assess an operator's performance against a predetermined performance criteria. Such an assessment is carried out to determine if an operator has exceeded an expected level of performance, and if so, to determine a bonus amount that is paid to the operator in addition to the operator's regular salary. This bonus payment that is added to the regular pay, is shown in block 525. If it is determined in block 520, that the operator has not exceeded the expected threshold, a regular salary is paid, as shown in block 530.

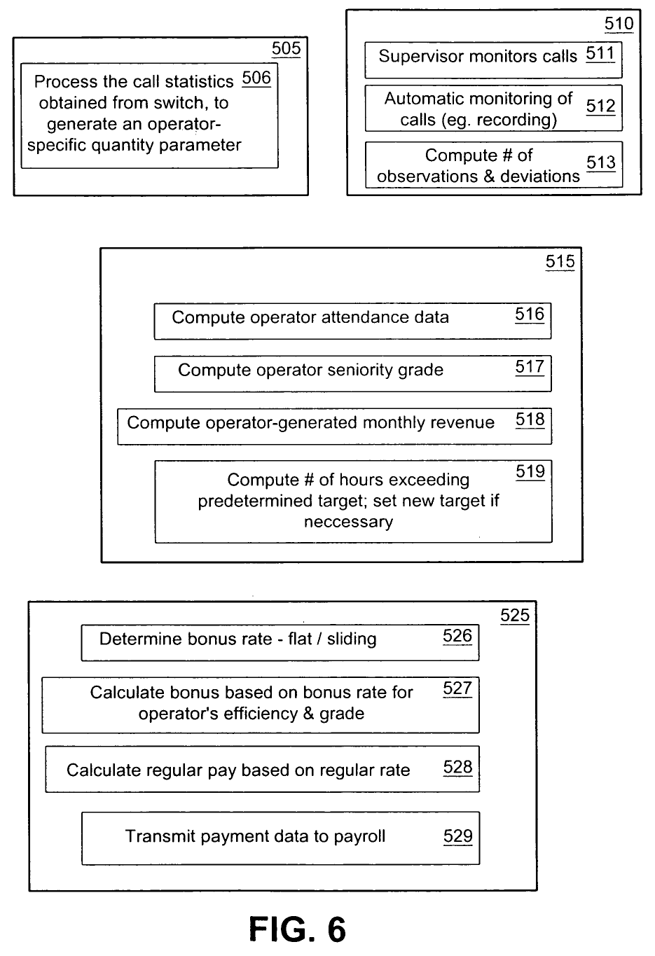

The blocks of FIG. 5 will be elaborated in further detail using FIG. 6, which shows certain functional blocks contained inside the blocks of FIG. 5. Drawing attention to block 506 of FIG. 6, which identifies one example among many, of a quantity parameter that was mentioned with reference to FIG. 5, call-related statistics from a switch are used to generate an operator-specific quantity parameter. Call-related statistics include, but are not limited to the number of calls forwarded from a communication switch to the WFMS 100, telephone numbers, call duration, originating source, call center identification, and operator identification.

Block 510 relates to an operator-specific quality parameter. Such parameters can be obtained by several manual as well as automatic means. For example, a supervisor may periodically and/or randomly monitor one or more phone calls that are handled by a particular operator, to determine if the call has been effectively handled by the operator. This monitoring may include the measurement of timing parameters such as operator response time, and also monitoring of the contents of the conversation to determine if the telephone customer has been provided satisfactory service. Such supervisory monitoring, which is referred to in the business, as observations, is often carried out in a pre-set schedule and manner that encompasses all the operators of one or more call centers. Any shortcomings on the part of the operator in terms of performance, such as absenteeism, response delays exceeding established thresholds, and customer dissatisfaction are typically referred to, in industry, as “deviations.” Consequently, the number and type of deviations is one measure of an operator's qualitative performance.

Automatic monitoring means of operator-specific quality parameters may include voice recordings using audio recording devices, and audio-video monitoring using devices such as video recorders.

Attention is now drawn to block 515 wherein operator efficiency parameters are calculated. One example was provided earlier with reference to FIG. 5. Additional factors that are utilized in arriving at operator efficiency parameters include several other parameters that are not provided via blocks 505 and 510. Such data includes for example, seniority and pay-scale. As one example, a first employee who has a seniority over a second employee is expected to have a higher efficiency parameter. In an alternative embodiment, when a pay scale is used as a factor, the bonus payment will be graded suitably. For example, a regular employee will be paid a larger bonus than a management employee. Other factors that are also used in alternative embodiments of this processing include financial data such as the amount of revenue generated by the operator over the period of time. Optionally, once the number of hours exceeding expected target has been determined, a new target for the following period of time may also be set.

Some aspects of the pay-out calculations are highlighted in block 525. These include determining the bonus pay, which can be a flat rate based on certain percentage values, or can be determined as a sliding rate depending on other parameters such as the operator's seniority of service. The pay-out data calculated in block 525 is then transmitted to payroll services. Such transmission will take place for example, by one computer that is a part of the WFMS to another that is associated with payroll services. Alternatively, hardcopies and softcopies of such data can also be provided to payroll personnel to enable disbursement of the money to the operators.

It should be emphasized that the above-described embodiments are merely possible examples of implementations and are set forth merely for providing a clear understanding of the principles. Many variations and modifications may be made to the above-described embodiment(s) of the disclosure without departing substantially from the spirit and principles of the disclosure. For example, it will be understood by persons of ordinary skill in the art, that several implementations upon several switches other than POTS switches can be carried out to implement this payroll system. All such modifications and variations are intended to be included herein within the scope of this disclosure and the present disclosure and protected by the following claims.

1. A payroll system comprising:
logic configured to obtain a set of switching statistics from a database of a communications switch;
logic configured to obtain a set of work statistics of an operator;
logic configured to determine an operator efficiency parameter by integrating the set of switching statistics with the set of work statistics;
logic configured to determine when the operator efficiency parameter exceeds an expected efficiency parameter.

2. The system of claim 1, further comprising logic configured to calculate a bonus payment to the operator.

3. The system of claim 1, further comprising:
logic configured to generate an operator-specific, quantity-parameter from the set of switching statistics;
logic configured to generate an operator-specific, quality-parameter based on the set of work statistics of the operator;
logic configured to determine the operator efficiency parameter by integrating the operator-specific, quantity-parameter with the operator-specific, quality-parameter; and
logic configured to determine the expected efficiency parameter of the operator based on a set of operator-specific information.

4. The system of claim 3, wherein the communications switch is a POTS switch located in a telephone central office, and wherein the set of switching statistics comprises telephone call statistics contained in the database of the POTS switch.

5. The system of claim 4, wherein the operator-specific, quality-parameter comprises a time of handling a set of telephone calls from customers.

6. The system of claim 4, wherein the set of operator-specific information includes at least one of an employment seniority grade, an operator attendance data, and an operator-generated monthly revenue.

7. The system of claim 1, further comprising:
means for generating an operator-specific, quantity-parameter from the set of switching statistics;
means for generating an operator-specific, quality-parameter based on the set of work statistics of the operator;
means for determining the operator efficiency parameter by integrating the operator-specific, quantity-parameter with the operator-specific, quality-parameter; and
means for determining the expected efficiency parameter of the operator based on a set of operator-specific information.

8. A method of operating a payroll system, the method comprising:
obtaining a set of switching statistics from a database of a communications switch;
obtaining a set of work statistics of an operator;
determining an operator efficiency parameter by integrating the set of switching statistics with the set of work statistics;
providing a bonus payment to the operator when the operator efficiency parameter exceeds an expected efficiency parameter.

9. The method of claim 8, further comprising:
generating an operator-specific, quantity-parameter from the set of switching statistics;
generating an operator-specific, quality-parameter based on the set of work statistics of the operator;
determining the operator efficiency parameter by integrating the operator-specific, quantity-parameter with the operator-specific, quality-parameter; and
determining the expected efficiency parameter of the operator based on a set of operator-specific information.

10. The method of claim 9, wherein the communications switch is a POTS switch located in a telephone central office, and wherein the set of switching statistics comprises telephone call statistics contained in the database of the POTS switch.

11. The method of claim 10, wherein the operator-specific, quality-parameter comprises a time of handling a set of telephone calls from customers.

12. The method of claim 10, wherein the set of operator-specific information includes at least one of an employment seniority grade, an operator attendance data, and an operator-generated monthly revenue.

13. The method of claim 9, wherein the communications switch is a packet switch in a data network, and wherein the set of switching statistics comprises switch usage information contained in the database of the communications switch.

14. The method of claim 9, wherein the communications switch is a server of a client-server data network, and wherein the set of switching statistics comprises switch usage information contained in the database of the communications switch.

15. The method of claim 14, wherein operator-specific, quality-parameter comprises a time of servicing a set of communications switch customer work requests.

16. The method of claim 14, wherein the set of operator-specific information includes at least one of an employment seniority grade, an operator attendance data, and an operator-generated monthly revenue.

17. A payroll system stored on a computer-readable medium, the system comprising:
computer-readable code that configures a device to obtain a set of switching statistics from a database of a communications switch;
computer-readable code that configures the device to obtain a set of work statistics of an operator;
computer-readable code that configures the device to determine an operator efficiency parameter by integrating the set of switching statistics with the set of work statistics;
computer-readable code that configures the device determine when the operator efficiency parameter exceeds an expected efficiency parameter.

18. The system of claim 17, further comprising computer-readable code that configures the device to calculate a bonus payment to the operator.

19. The system of claim 17, further comprising:
computer-readable code that configures the device to generate an operator-specific, quantity-parameter from the set of switching statistics;
computer-readable code that configures the device to generate an operator-specific, quality-parameter based on the set of work statistics of the operator;
computer-readable code that configures the device to determine the operator efficiency parameter by integrating the operator-specific, quantity-parameter with the operator-specific, quality-parameter; and
computer-readable code that configures the device to determine the expected efficiency parameter of the operator based on a set of operator-specific information.

20. The system of claim 17, wherein the communications switch is a POTS switch located in a telephone central office, and wherein the set of switching statistics comprises telephone call statistics contained in the database of the POTS switch.

21. The system of claim 20, wherein the operator-specific, quality-parameter comprises a time of handling a set of telephone calls from customers.

22. The system of claim 20, wherein the set of operator-specific information includes at least one of an employment seniority grade, an operator attendance data, and an operator-generated monthly revenue.
